(19) United States
(12) Patent Application Publication
(10) Pub. No.: US 2010/0250618 A1
(43) Pub. Date: Sep. 30, 2010

(54) METHODS AND SYSTEMS FOR BUILDING, MANAGING AND SHARING A DIGITAL IDENTITY OF A USER OVER A SOCIAL NETWORK

(76) Inventor: JEAN DOBEY OUREGA, Verdun (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/411,588

(22) Filed: Mar. 26, 2009

(51) Int. Cl. G06F 17/30; G06F 15/16; G06F 7/00

(52) U.S. Cl. 707/803; 709/204; 707/E17.032; 707/E17.044

(57) ABSTRACT

There is provided a method for building a digital identity of a user over a social network comprising: receiving profile attributes associated with a user; generating a plurality of digital booklets comprising digital information associated with the attributes; updating the booklets over time; and tracking and cataloguing the booklets over time. There is further provided a method for sharing an identity of a user over a social network comprising: receiving from a first user a request to create at least one digital subset-identity, where each one of the at least one subset-identity is associated with at least one digital booklet containing digital information associated with attributes of the user; for each one of the at least one subset-identity, setting corresponding privacy rules; and controlling other users' access to the at least one subset-identity in accordance with the privacy rules. There is also provided a method for generating a biography associated with a user. The attributes comprise intrinsic attributes that inherently define the user and extrinsic attributes that comprise information about social objects and about relations of the user with the social objects. There is further provided systems for doing the same.

### FIELD OF THE INVENTION

This description relates generally to social networks, and more precisely, this invention pertains to computer-implemented methods and systems for building, managing and sharing a digital identity of a user over a social network.

### BACKGROUND OF THE INVENTION

Computer mediated social interaction and networking was suggested early on. There were many early efforts to support social networks via computer-mediated communication.

Early social networking websites were launched in the mid-90s. Some were focusing on ties with former school mates, while others were focusing on indirect ties. User profiles could be created, messages sent to users held on a “friends list” and other members could be sought out who had similar interests to yours in their profiles.

By the end of the 90s, trust-based and friendship-based concepts of social networking emerged. Innovations included not only showing who is “friends” with whom, but giving users more control over content and connectivity.

Between 2002 and 2004, social networking sites became part of mainstream users worldwide. Major players included Friendster, MySpace, Bebo, and Facebook. Facebook is today the most popular social network, and claims over 200 million registered users worldwide.

Various social networking sites have sprung up catering to different languages and countries. It is estimated that combined there are now over 200 social networking sites using these existing and emerging social networking models, without counting the niche social networks (also referred to as vertical social networks) made possible by services such as Ning.

Social networks have always been criticized for being too loose with the information provided by the members. The wealth of this information attracts profilers from various industries.

It has become increasingly common for colleges and universities to use Facebook to investigate violations of campus policies. Students who violate these policies may be discovered through photographs of illicit behavior, membership in groups, or simply information posted on the Facebook website.

Students, angered by the monitoring, have begun to submit “red herring” party listings

In addition, 10 percent of admissions officers from prestigious schools said they had peeked at sites like Facebook and MySpace to evaluate college-bound seniors. Of those using the profiles, 38 percent said it had a “negative impact” on the applicant, according to Kaplan Inc., the education services company that polled the officers.

Employers are increasingly scouring the Internet for “digital dirt” to help them weed through job candidates. In fact, 83.2 percent of recruiters admitted to using online search engines in 2007 to uncover information about candidates, according to Execunet. Of these recruiters, 43 percent admitted to eliminating candidates based on the negative information they found.

As the number of job seekers continues to increase and the pressure to reduce costs continues, companies seek alternatives to paid background checks leading to the appearance of sites specializing in “social reference checks” that will make a background check on an employee through social networks.

Official organizations do try to prevent users that once online their information is extremely hard to remove. These privacy issues are becoming so large that a new business model was born: Reputation Guardians. Companies such as ReputationDefender target teenagers' parents by offering monitoring services of their children social behavior.

Even CNN pushed a story on office/facebook relationships in January 2009 advising that “you should be monitoring your online content as though your current and future boss can see it, even if they aren't on your buddy list.”

Current social networks are basing their revenue stream on advertising and data sharing. Both models imply the spreading of information that could be considered private.

Patents are even being filed that shows methods of identifying the influential elements within social networks in order to push targeted ads. The first of the pack is Google with its profiling capabilities over a vast amount of sites.

Every day more resources become available to the social network users to warn them about the privacy problems they can encounter if they are not careful about their personal information.

In 2009, in an effort to increase awareness of the online privacy issues, the US House of Representatives, following the European Council, has approved Bill H. RES.31 declaring January 28th, a National Data Privacy Day.

With all these facts, it is hard to believe that social network users are not aware of the potential consequences of their actions. A Rubicon survey, however, still shows that a high number of users would feel embarrassed if part of their profile would become known to some people.

Another study claims that: 43% of adults think it would be pretty easy for someone to find out who they are from their profile; 23% of teens say it would be pretty easy; 33% of adults with profiles think that they would have to work at it, but that someone could eventually find out who they are; 40% of teens say the same; 20% of adults think that it would be difficult for someone to find out who they are; 36% of teens say it would be difficult for someone to find out who they are.

It is clear from these numbers that the perception of privacy differs as one grows older. Furthermore, it strongly suggests that all the industry warnings do not reach the target audience.

Even if they learned about the risks, their options are often limited to the poor and complex settings offered by their favorite sites. The other alternative is to create additional profiles on these networks.

24% of users that have multiple social network accounts do so to either separate their personal from their professional life or to represent a different aspect of their personality.

These users are sharing information because they do not have easy access to preemptive information on social networks, and do not possess the tools that would give them the benefits of sharing with the privacy and the security to protect their future.

On the surface, social network users advance that their primary reason of using such tool is to keep in touch with their close friends. However, when one looks at the deeper significance of social networks one realizes that social networks are a crucial element to help anyone trying to define himself and to gain self-confidence.

It is important to understand that a user will always organize his social environment by priority. Below is an example of such perceived audience from the closest relationships to the furthest.

Each social user attributes an importance to the feedback he obtains from each of these groups. Hence, a positive feedback from a friend will be significantly more self-fulfilling than one from a professor.

It is important for the user to receive feedback concerning the elements that define him. Social sites typically focus on such aspects.

When looking at the various elements that define today's youth, we realize that materialist behavior is not only important but also growing. Surprisingly enough, social networks have always steered away from using social objects for identity purposes trying instead to use them for shopping activities. According to a warning given to the Annual Meeting of the Royal College of Psychiatrists (U.K.), reported by Snugd, the Facebook Generation who use internet for everything and who have never known a world unless they surf on-line are growing up with a dangerous view of the world and their own identity. They are going through major identity crisis. People who born after 1990 have grown up in a world dominated by online social networks such as Facebook and MySpace.

Many of these youngsters use Internet as the main medium to communicate. Their relationships are quickly disposed at the click of a mouse. Because of the online social networking, people find the real world boring and unstimulating. These interactions between people in the digital realm reduced sensory experience; person's expression/body language/voice/tone aren't there; and this can shape one's perceptions of such an interaction differently.

Online session changes the perception to a [unreal, fantastic, imagery] dreamlike state, and this unnatural blending of mind with the other person leads to entirely different meaning to friendships and relationships. Because of this online mess, youngsters are going through the stages of vulnerable to impulsive to suicide.

The lack of feedback for material possessions in social networks creates an important void in the road for stronger self-esteem. Without that relation placed in the context of each perceived audience, a social user can never feel as complete online as in real life.

When considering the above issues one should realize that they are normally inexistent in the real world. In fact, privacy, image management and material interactions are present in our everyday life that they are often taken for granted.

Without the natural rules of social interactions, technology will use online relationships for capital gain at the detriment of the interlocutors.

### SUMMARY OF THE INVENTION

It is therefore an object of the present invention to provide methods and systems that overcome the above drawbacks.

As a first aspect of the invention, there is provided a method of building a digital identity, the method comprising:
receiving profile attributes associated with a user;
generating a plurality of digital booklets comprising digital information associated with the attributes;
updating the booklets over time; and
tracking and cataloguing the booklets over time.

The method is preferably computer-implemented.

The attributes preferably comprise intrinsic attributes that inherently define the user and extrinsic attributes that comprise information about elements of his environment and about relations of the user with such elements (also referred to herein as social objects).

The tracking and cataloguing process of the booklets over time preferably comprises tracking and cataloguing user's real life experience with the social objects over time through the booklets.

The attributes are preferably stored into a first database and the generated digital booklets are stored into a second database.

Preferably, the method further comprises generating data records associated with the process of tracking and cataloguing the booklets over time, and storing the data records into a third database.

The social objects are preferably related to at least one category of products, animals, things, people, places and interests.

The received attributes can be in a textual or a multimedia format or any other digital format.

Preferably, the method is implemented on a computer server connected to a social network, and the profile attributes are automatically collected from one or more databases independent from the computer server.

Preferably, the generating process of digital booklets is carried out automatically using predefined booklet generating criteria.

Preferably, the profile attributes comprising intrinsic and extrinsic attributes are stored into a first database, and the digital booklets are generated based on at least one social object among the social objects by extracting information related thereto from the first database.

Preferably, the tracking and cataloguing process of the booklets over time is carried out automatically using predefined tracking and cataloguing criteria.

The tracking and cataloguing criteria can be predefined by the user.

The method can be implemented on a computer server connected to a social network, wherein the profile attributes are transmitted by the user using at least one of a user interface connected to the computer server and a device operating independently of the computer server.

Preferably, the method further comprises receiving a request from the user for generating the digital booklets, where the request comprises the booklet generating criteria.

Preferably, the booklet generating criteria comprises an identification of at least one social object among the social objects, and the digital booklets are generated based on the at least one social object identified by the user.

The updating process of the booklets over time can be carried out by the user.

As a second aspect of the invention, there is provided a system for building a digital identity of a user, the system comprising:
a first module for receiving profile attributes associated with the user;
a first database for storing the attributes;
a second module for generating a plurality of digital booklets comprising digital information associated with the attributes;
a second database for storing the generated booklets;
a third module for updating the booklets over time;
a fourth module for tracking and cataloguing the booklets over time and for generating data records associated therewith; and
a third database for storing the generated data records.

The system preferably further comprises a user interface adapted to be connected to the first module for enabling the user to manually upload the profile attributes.

The user interface can comprise features for enabling the user to define booklet generating criteria, wherein the creation of a plurality of digital booklets is carried out as a function of the defined booklet generating criteria.

The system preferably further comprises a fifth module adapted to be connected to the first module for automatically collecting the profile attributes from a remote device through a data network.

As another aspect of the invention, there is provided a method of sharing a digital identity the method comprising:
receiving from a first user a request to create at least one digital subset-identity, where each one of the at least one subset-identity is associated with at least one digital booklet containing digital information associated with attributes of the user;
for each one of the at least one subset-identity, setting corresponding privacy rules; and
controlling other users' access to the at least one subset-identity in accordance with the privacy rules.

Preferably, the method is computer-implemented over a social network.

The corresponding privacy rules can comprise access privileges comprising information allowing for identifying users eligible for visualizing the digital information contained in the at least one digital booklet, and, in this case, the process of controlling other users' access to the at least one subset-identity comprises determining users eligible to visualize information contained in the at least one digital booklet and granting the eligible users the access to visualize in accordance with the access privileges.

The settings of access privileges can further comprise the process of setting hierarchical access rules between the at least two subset-identities for enabling eligible users granted access to a subset-identity of an upper level to be automatically granted access to one or more subset-identities of a lower level, and, if required, the process of automatically granting the eligible users access to the at least two-subset identities in accordance with the hierarchical access rules.

The corresponding privacy rules can also comprise interaction privileges comprising information allowing for identifying users eligible to interact with at least one other eligible user through the at least one digital booklet, and, in this case, the process of controlling other users' access to the at least one subset-identity comprises determining users eligible to interact with at least one other eligible user through the at least one digital booklet and enabling the eligible users to interact with the at least one other eligible user through the at least one digital booklet in accordance with the interaction privileges.

Preferably, the process of enabling the other users to interact with at least one other eligible user through the at least one digital booklet comprises enabling the other users to use the at least one digital booklet as at least one of a mean of interaction and a subject of discussion.

The corresponding privacy rules can further comprise administration privileges comprising information allowing for identifying users eligible to carry out administration actions in connection with the at least one digital booklet, and, in this case, the process of controlling other users' access to the at least one subset-identity comprises determining users eligible to carry out administration actions in connection with the at least one digital booklet and enabling the eligible users to carry out the administration actions in accordance with the defined administration privileges.

The administration actions preferably comprise at least one of updating content of the at least one booklet, editing content of the at least one booklet, setting rules for receiving feeds through the at least one booklet and setting privileges to other users in connection with the at least one booklet.

The information allowing for identifying eligible users can consist of user selection criteria comprising at least one of a type and a group of eligible users. It can also consist of predefined identifiers allowing for uniquely identifying the users.

The request can be transmitted by the user using at least one of a user interface connected to the computer server and a device operating independently of the computer server.

The method is preferably implemented on a computer server connected to the social network, and the other users consist of users pre-registered on a database connected to the computer server or on another platform independent of the computer server.

As a further aspect of the invention, there is provided a system for sharing a digital identity, the system comprising:
a first module for receiving from a user a request to create at least one digital subset-identity;
a second module for associating each one of the at least one subset-identity with at least one digital booklet stored in a first database, the at least one digital booklet containing digital information associated with attributes of the user;
a second database for storing data records about the at least one subset-identity;
a third module for setting, for each one of the at least one subset-identity, corresponding privacy rules;
a third database for storing data records about the privacy rules;
a fourth module adapted to be connected to a social network and to the first, second and third databases for controlling other users' access to the at least one subset-identity in accordance with the privacy rules.

The system preferably further comprises a user interface adapted to be connected to the first module for enabling the user to define manually the request.

The user interface is preferably further connected to the third module for enabling the user to set manually the privacy rules.

As a further aspect of the invention, there is provided a method of generating a biography, the method comprising:
providing a first database storing data records associated with a plurality of digital booklets comprising digital information associated with attributes of a user, where the data records comprise tracking records of time-based events associated with the digital booklets
receiving at a computing device connected to the first database a request for generating a biography associated with the user, the request comprising information allowing for determining at least one booklet associated with the request and a time frame to be covered by the biography;
inquiring the first database as a function of the information and retrieving corresponding data records thereof;
organizing events associated with the corresponding data records as a function of time; and
displaying the time-based events in a form of biographical coverage.

Preferably, the method is computer-implemented.

Preferably, the biography associated with a user consists of a biography associated with a social object among the social objects of the user.

As another aspect of the invention, there is provided a system for generating a biography associated with a user, the system comprising:
a database storing data records associated with a plurality of digital booklets comprising digital information associated with attributes of a user, where the data records comprise tracking records of time-based events associated with the digital booklets;
a first module for receiving a request for generating a biography associated with a user, the request comprising information allowing for determining at least one booklet associated with the request and a time frame to be covered by the biography;
a second module for inquiring the first database as a function of the information and retrieving corresponding data records thereof;
a third module for generating the biography, where the generating comprises organizing events associated with the corresponding data records as a function of time; and
a fourth module for displaying the time-based events in a form of biographical coverage.

The system preferably further comprises a user interface for enabling users to define the request for generating a biography.

### BRIEF DESCRIPTION OF THE DRAWINGS

Further features and advantages of the present invention will become apparent from the following detailed description, taken in combination with the appended drawings, in which:

FIG. 1 is a flow chart which shows an embodiment of a method for building a digital identity of a user over a social network;

FIG. 2 is a flow chart which shows an embodiment of a method for sharing a digital identity of a user over a social network;

FIG. 3 is a flow chart which shows an embodiment of a method for generating a biography associated with a user over a social network;

FIG. 4 is a bloc diagram which shows an embodiment of a system for building a digital identity of a user over a social network;

FIG. 5 is a bloc diagram which shows an embodiment of a system for sharing a digital identity of a user over a social network;

FIG. 6 is a bloc diagram which shows an embodiment of a system for generating a biography associated with a user over a social network;

FIG. 7 illustrates an overview of various parts of a multi-facet system;

FIG. 8 illustrates an overview of a digital identity building module

FIG. 9 illustrates an overview of facet creation & management

FIG. 10 illustrates an overview of facet features;

FIG. 11 illustrates an overview of a system access control;

FIG. 12A) AND B) illustrate personal relationships mapping based on facets; and

FIG. 13 illustrates collaborative relationships mapping based on facts.

It will be noted that throughout the appended drawings, like features are identified by like reference numerals.

### DESCRIPTION OF THE PREFERRED EMBODIMENTS

Solutions provided by the present invention:

The present invention provides solutions for users who desire to build a digital identity over a social network based at least in part on elements of their environment (also referred herein as social objects). It also provides solutions for users who desire to partition their identity over social networks into a plurality of subset-identities (also referred herein as facets) in order to be able to customize privacy rules for each one of the their facets. For a given user or a group of users, the present invention enables users to hide one or more facets while providing access to one or more other facets. This way they can manage their images and control the impressions other people form of them. The present invention also provides solutions for building a biography based on social objects.

General Overview

This invention is referred to herein as Hibe.

Hibe is a social utility platform that let users (individual or corporate entity) build an online presence.

First, Hibe let users create a social environment, along with elements that define them (their identity) and people they interact with in real life. Second, Hibe let users create various social contexts (for different purposes) as a subset of their social environment.

Elements of a user social environment in the digital realm are represented by Booklets: digital symbols through which they track their life experience and interactions with others over time, in the context of these elements. The user's life experience and interactions with each element are represented within the booklet by factual events, textual posts, and multimedia content (photos, videos, sound) associated with such an element. Users can create booklets just about everything in their social environment, including people, animals, products & things, places, interests & causes, etc.

Users can then associate a subset of booklets (that define them or the image they want to portrait) and people (they want to interact with) with in each social context (aka Facet), depending on the purpose of this social context. Thus, with Hibe, users can mimic their everyday life experience in the digital realm, with the natural rules that dictate our behaviour in the real world.

It's more than a typical social network. Hibe is a social engine that brings reality into the digital realm with natural rules. Hibe does not drop users within a pre-built network. Hibe let users build their own network based on their real life connections. Of course, users may share connections (for example, a friend or an interest) with others, but others people will only have access to a user social environment on permission-based. This way, Hibe eliminates any prying eyes a user want to keep out of his/her private life or activities, online and offline.

In social interaction, people's perception of the identity of a person is mediated by the personal viewpoint of those people. In order to control the impressions other people form of them, users of a social network may only grant selective access to their profile information according to the relationship with the observer, from the perspective of the profile owner. When developing the present invention, a unique interaction framework has been created, which includes the user's identity and his various relationship types with elements of his environment (or social objects).

A—The User Identity

The identity is the core element of any social network. It is whatever makes the user definable and recognizable, in terms of possessing a set of qualities or characteristics that distinguish him from others. For institutions & corporate entities, the corporate identity is the “persona” of a corporation which is usually visibly manifested by way of branding and the use of trademarks. An important part of the user identity is how he views himself both as a person and in relation to other people.

In everydays social interaction, impression management is the process through which the user will try to control the impressions other people form of him. The user will attempt to influence the perceptions of other people about his identity, by regulating and controlling information in his social interaction. For a corporate entities, brand identity is how these entities want the consumer to perceive the brand, and by extension the branded company, organization, product or service.

Using elements of his identity, the user creates subset-identities based on his relationships and a social context, and then request feedbacks that will help improve his image. This process is known in real as identity formation. Pieces of the individual's actual identity include a sense of continuity, a sense of uniqueness from others, and a sense of affiliation.

The present invention's uniqueness consists primarily of the following:

Social Objects:

There is a need for one to express himself through his relations with social objects and provide an environment that will allow the user to describe these relations over a period time. In addition, using a database comprising elements of the environment, one can make list of social objects based on his preferences.

The benefit of using such a system is to be flexible enough to allow a user to identify himself, for example, through music, movies or any other social objects. Corporate entities will use for example their products, services services, as social objects. Corporate entities can also use their brands which are a collection of symbols, experiences and associations connected with a product, a service, a person or any other artifact or entity, as social objects.

B—User Relationships

Users behave differently depending with who they develop a relationship. As such, the present invention provides an environment that can support a wide variety of relationship types. Additionally, the present invention provides tools for users to customize their profile based on the relationship type.

Relationship Types:

Users have various degrees of relationship in real life and the present invention is dedicated to represent them in the community.

The present invention tailors the user experience based on his various relationships. These may include: Friends, Family, Co-Workers, Groups, Fans & Favorites, Public, or any other social interaction context.

Another advantage of the present invention is its ability in using these relationships to reflect real life interactions within the virtual world. Each relationship type is associated to a feature set that appropriately defines it.

Relationship Customization:

The present invention provides the user with the necessary tools to model each relationship based on his real life interaction. Basically, the element of his profile and the activities on the platform are shared based on the user's preferences.

Corporate Relations:

Corporations and institutions can participate in a value added relationship with individuals and consumers. Should the corporate entity have a proper communication plan, the present invention provides them with the necessary tools to establish contact and to nurture a social commitment from the social network member.

The present invention uses a front-door policy for this type of relationships integrating concept of permission marketing within for example a Fans/Followers relationship type.

In developing the above mentioned functionalities, the present invention allows for moving forward to replicate in online communities, the real social behavior of Internet users. This invention also aims to recreate the ease and the natural aspects of social interactions.

General System Features Overview

I—Multi-Facet System

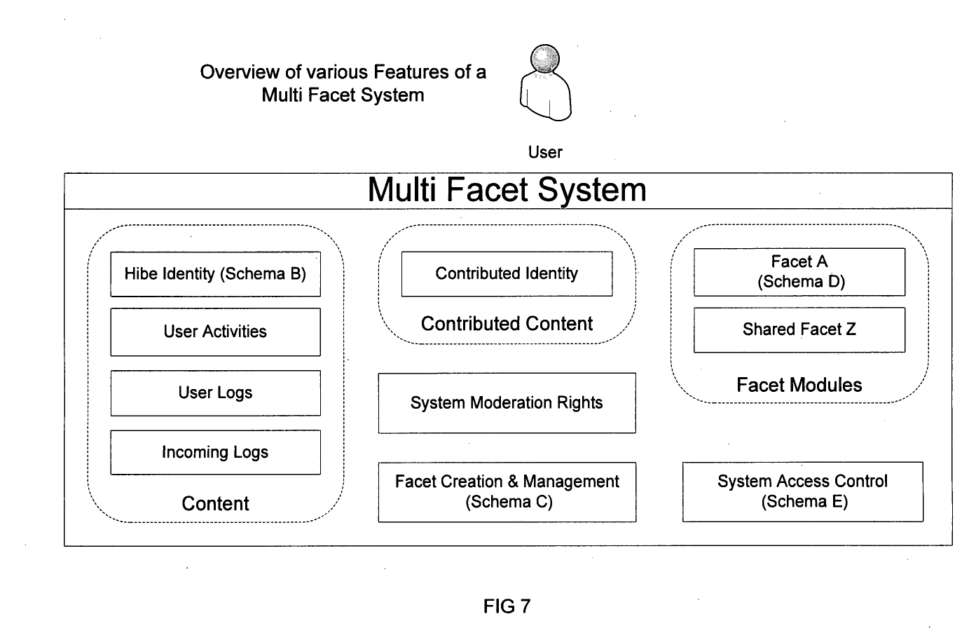

Referring to FIG. 7, an overview of various features of a multi-facet system is illustrated (hereinafter “HMFS or Hibe Multi-facet System”);

Hibe is a constituted name given in reference to the present invention when implemented over a social network.

Facet is defined as a subset-identity of a user; it reflects a given view or image (among a plurality of views) of the user.

HMFS is a system that manages the rights to access and export user-related content, as well as the rights to use features or to view information in a social context. The main components of the system are:

User-Related Content:

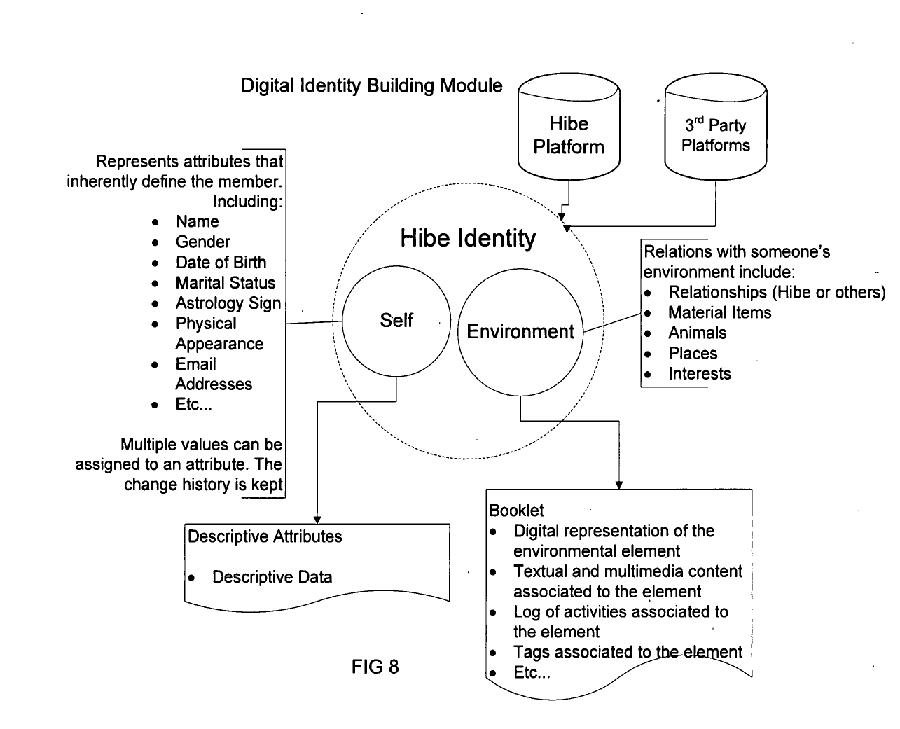

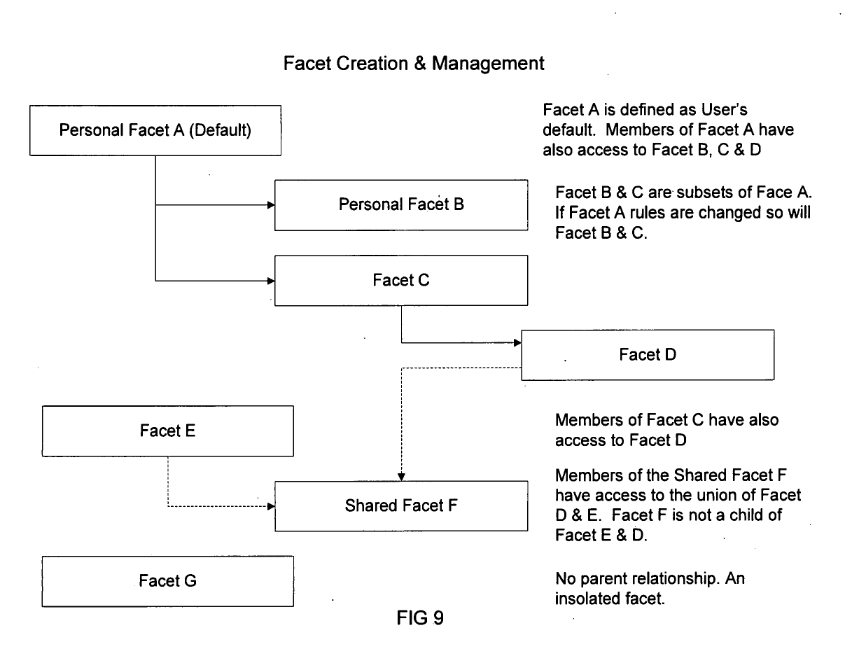

It consists of the aggregation of all content related to the user including his identity from the Hibe Identity Module (see FIG. 8), all his activities and their logs on Hibe. The Content component also includes the activities and their logs on all booklets and profile attributes, the user automatically or manually subscribed to.

To illustrate the last point, a user may have asked to receive a feed (a stream of activity log) of the activities associated to the Grand Canyon, as he spent his honeymoon over there. Or he may automatically receive all new photos (activity) associated to the Honda Civic 1989, as he is using that digital symbol for one of his booklet.

Contributed Content:

It consists of exported (“contributed”) elements of the User's Hibe Identity that are associated to a collaborative social context (“Shared Facet”).

It can include a copy of some of the user's booklets and of some of his descriptive data such as lists/albums, photos and videos.

The content is separated from the User-related Content as moderation rights may change to allow any members of the Shared Facet to modify or delete data from the content.

Social Contexts (“Facets”):

Each facet represents a social context that includes privileges, including, access, interaction and administration rights to features and to both types of Content. A facet serves as a self-presentation of the user to others, aiming to influence the perception of his image. Thus, a facet is a perception management zone in which a user not only portraits a given identity of himself, but also includes a list of people he want to interact with by enabling them to access elements of such identity.

Each facet is a subset of your reality; and people you want to access such a facet are selected accordingly between a pool of peers (friends, colleagues, relatives, fans, dating mates, employers, complete strangers, etc.).

Facet Creation & Management:

It consists of a component that allows a user to define his default image, the image he wants to project on each of his Facets, and the relations between his Facets.

System Access Control:

It consists of the association between Facets and the User's contacts. The component manages the right to access each facet.

System Moderation Rights

This component is not user-specific but system wide. It controls the moderation rights of facets when these are transferred to another user.

II—Digital Identity Building Module

Referring to FIG. 8, an overview of a digital identity building module (hereinafter “HIM” or “Hibe Identity Module”) is illustrated.

HIM represents a process that captures data regarding a user, that organizes it manually or automatically and that displays it through a profile and its booklets.

Capture:

The information that feeds the module comes from: (1) manually entered data from a user interface; (2) derived data by the system from the user's activities; (3) from a third party platform where the data was either entered or derived.

In order to manage the information, HIM will always try to take the information from the third party and annex it to its own. In some cases, it might be impossible. HIM will adapt and allow the management of the data as if it was on its own system.

Manage:

HIM defines two types of user data.

A—Descriptive data (“Self”) that defines the user without specific relations with the outside world. Examples are: Name, Gender, and Weight, Date of birth, Email Address, Generic Photos, etc. These attributes are also referred to herein as intrinsic attributes.

B—Data related to the specific relations with social objects that defines the user. These include for example: the people he knows, the products he uses, the places he loves, the causes he advocates or his favorite pet. Such information is also referred to herein as extrinsic attributes.

HIM separately manages and stores Type A data and its changes as generic descriptive data.

HIM or the User creates booklets in which Him or the User inserts elements (also called social objects) of the Type B data.

Each booklet comprises: (1) a digital representation of the related element; that representation can be created by user, imported from a generic Hibe database, or imported from a third party platform; (2) the related data from the Capture process; (3) the log of activities related to that booklet element; (4) the manually entered or derived metadata to allow better booklet management; etc.

Display:

In order to display the user's identity, HIM separates the descriptive data from the booklets giving each descriptive data and each booklet access rights that are managed by the Hibe Facets.

III—Subset-Identity (Facet) Creation & Management

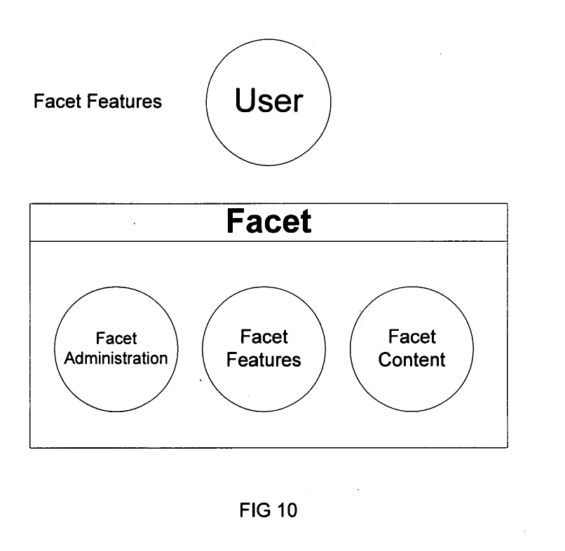

Referring to FIG. 10, an overview of a facet creation & management functionalities is illustrated.

A facet can be manually created by the User or auto-generated.

The system can automatically generate default facets based on generic relationships and contexts: for example “Friends Facet”, “Family Facet”, “Co-Workers Facet”, “Followers & Fans”; etc.

As facets represent the social contexts in which one can be seen, a user will always have at least one, his default.

Facets may be set in a hierarchical manner so that members of the parent facet are automatically granted access to the facet's children. Linking a non-shared facet to a shared facet is not considered hierarchical.

IV—Subset-Identity (Facet) Structure

Referring to FIG. 9, an overview of a facet is illustrated.

A facet is a set of rules and rights that defines a given social context in which the user interacts with others. It comprises three components:

1) Administrative Rights

A facet can be shared among a group of individuals who will see it in their profile. If shared, all facet members will need to associate it with one or more “non-shared” ones. A shared facet possesses its own interface, otherwise it is the interface of the User's profile.

The administration components also contain the administrators of the facet. A facet may see its moderation rights transferred. If so, the moderation rights become managed by another module which can be the Moderation Rights Module outside the facet.

A facet may be visible or not. A visible facet tells about its existence but does not grant access.

2) Content Rules

Content rules define: a) designated elements of the Hibe Identity Module that the facet members can view; b) If shared, designated elements of the Hibe Identity Module that the facet members can view from the shared context; c) designated types of the User's activity-related data that the facet members can view; d) designated types of the User's activity-related data that will be pushed to the profile of each facet member; e) designated types of the facet members' activity-related data, the User wants to receive.

3) Feature Rights

This component provides the access rights to the various features of a facet. These are of two kinds: a) features related to the content of the facet, if any, such as “delete a shared content” or “comment on a photo”; b) features related to the overall context, such as “right to post a message”, or “right to post a photo”. It also includes the various communication features the facet members can use.

V—System Access Control

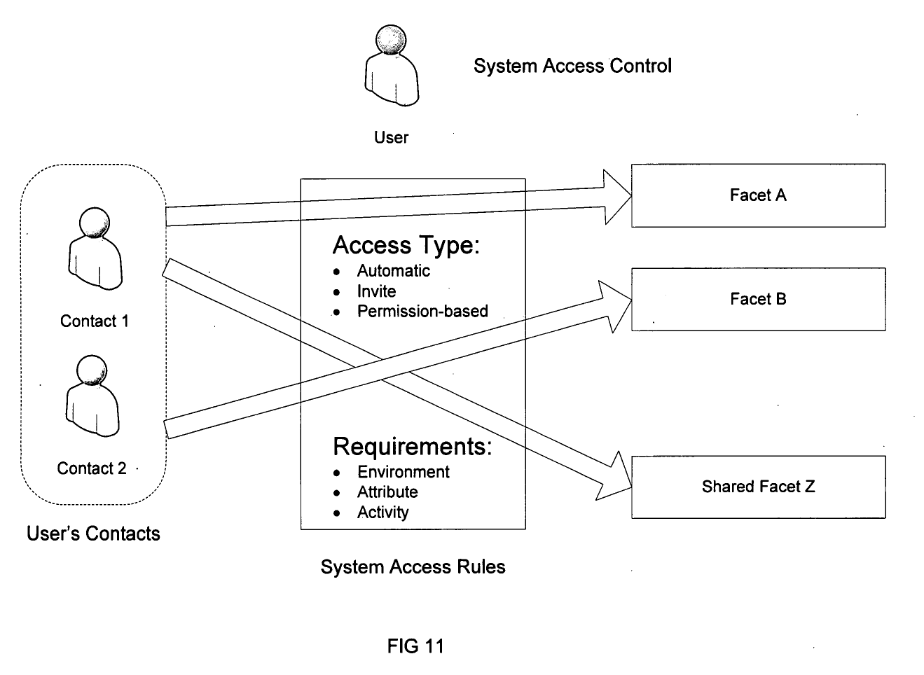

Referring to FIG. 11, an overview of a System Access Control is illustrated.

This module controls the rules of accessibility to each facet in control of the User.

An individual can be granted access to multiple facets of the User. Looking at the User's profile, the individual would see a single interface with the aggregated data and rights from the various facets he is a member of.

Facet access is managed through two variables: the access type that determines how a member is being granted access to a facet and the requirements that determines the prerequisites to receive such grant.

A—Access Types

a) Access can be automatically granted to anyone who meets the requirements; b) access can be granted only if the facet administrator selects or invites the members individually; c) access can be granted on request only.

B—Requirements

a) Access grant may be restricted based on the Hibe Identity of the members such as: i) Symbols used for Booklets (contacts, places, objects, animals, brand, cause, . . . ); ii) descriptive attributes such as age, gender, and education;

b) access grant may be restricted based on the activities of the members such as: i) facet membership (user must be a member of another facet of the administrator's profile); ii) activity level such as number of photos posted, number of products created, etc.

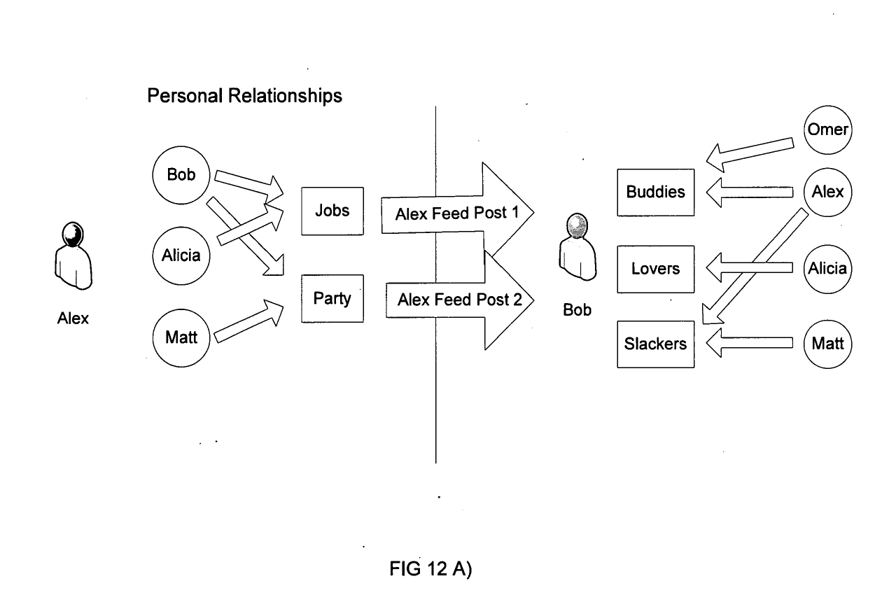

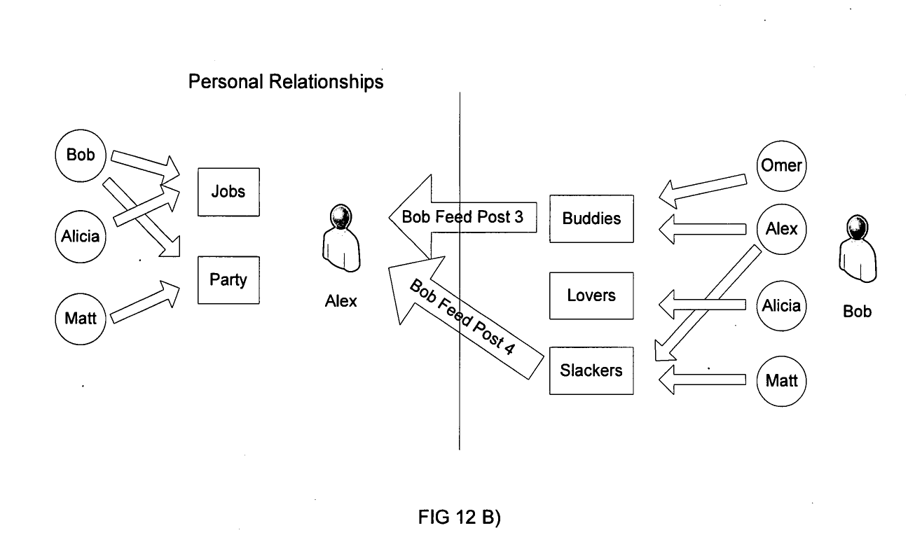

Referring to FIG. 12A) and B), personal relationship mapping based on facets is illustrated. First, referring to FIG. 12A), on Alex's profile: Bob views Party & Jobs aggregated profiles (Party∪Jobs ), Alicia views Jobs profile, and Matt views Party profile.

On Bob's profile: Post 1 is viewed by Alex ((Slackers∪Buddies)∩(Jobs)+Alex), and Post 2 is viewed by Alex & Matt ((Slackers∪Buddies)∩(Party)+Alex);

Referring to FIG. 12B), on Alex's profile, Post 4 is viewed by Bob & Matt ((Jobs∪Party)∩(Slackers)+Bob);

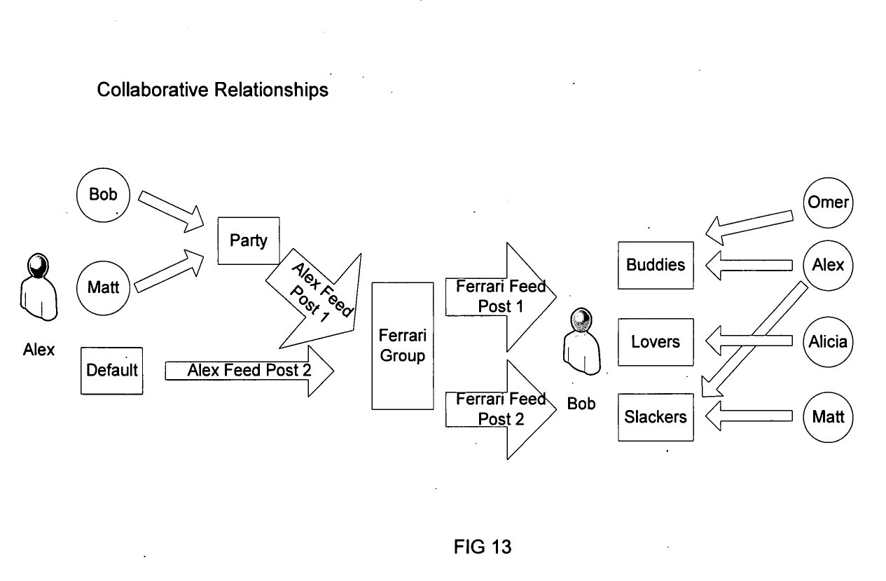

Referring to FIG. 13, collaborative relationship mapping based on facets is illustrated. On Alex's profile, Post 1 is viewed by Bob, Matt & Group Members, Post 2 is viewed by Alex's default privacy settings & Group Members.

On Bob's profile, Post 1 is viewed by (((Party∪Group)+Alex)#(Buddies∪Slackers)), and Post 2 is viewed by (((Alex's Default∪Group)+Alex) #(Buddies u Slackers));

In the Ferrari Group, both posts can be viewed by group members;

Detailed Description of Methods and Systems:

I—Building a Digital Identity

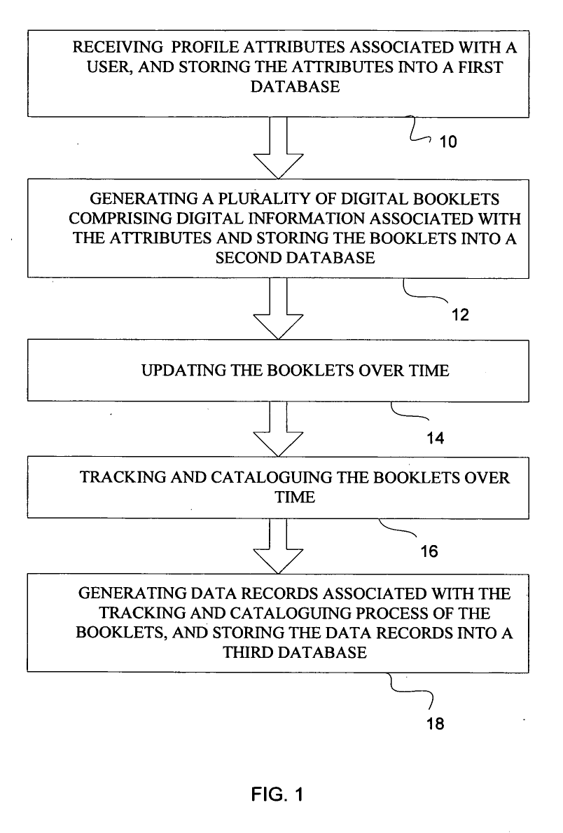

Referring to FIG. 1, there is provided a method of building a digital identity of a user. The first step of the method consists of receiving profile attributes associated with a user 10. The profile attributes can be manually provided by the member, via a user interface 56 for example, or automatically collected from a local or remote database or device using an attribute collecting module 40 for example. The received attributes can be in any digital format, for example in a textual or a multimedia format. The profile attributes are stored in a first database 50.

The profile attributes are divided into intrinsic attributes and extrinsic attributes. The intrinsic attributes generally comprise static information about the member, information that is related to his own person, such name, address, age, profession, horoscope, gender, physical appearance, marital status, etc. In other terms, the intrinsic attributes inherently define the user.

Regarding the extrinsic attributes, it comprises information about social objects (also called elements of his environment) and about relations of the user with these social objects. A social object can be related to a material object, an animal, a person, a place, an event, a group of interest, etc.

The second step consists of generating a plurality of digital booklets comprising digital information associated with the received attributes 12. When the first step of receiving the attributes 10 is carried out separately in term of time of the second step of generating the booklets 12, the attributes are extracted from the first database 50 and are converted to a convenient digital format to be integrated in the booklets if required.

It should be understood by a person skilled in the art that each generated booklet is independent from the others in term of access and data continence, and that it can be constituted of one or more digital files. However, booklets may share the same intrinsic and extrinsic attributes associated to the user. Each generated booklet is associated with an identifier that uniquely identifies the booklet. The identifier can be a number, an alphabetical serial number, an alphabetical name or any other type of identifiers. In general, each booklet is related to a given aspect of the user, for example with a given social object among the social objects related to the user. The booklets are stored in a second database 52.

As an example, extrinsic attributes of a given user can comprise the following social objects: a house, a pet, a musical instrument and an employer. In this case, four different booklets can be generated, each booklet being related to a distinct social object. The booklet related to the house can comprise information reflecting the relation between the user and the house, such as a date of purchase, a picture of the house, a price of purchase, renovation experience, real estate agent identity and his picture, and any other information defining the experience history therebetween.

In another application, the booklet can be use for evaluation and rating purpose within an organization. Indeed, in the context of a SNS where an organization has all staff, employees can maintain a booklet on each supervisor to track periodic interaction with the said supervisor. Students can also do the same for professor. In both cases, these booklets can be sent to a superior entity of the supervisor or the professor for rating and evaluation purposes. This same process can be done by the employees for the organization of any pertaining entity of such an institution.

A further application of the booklets is in the field of commerce. For example, a user can maintain a booklet about his car, from the date his purchased the vehicle. Then, when come the day to sell the car, the booklet can be valuable sources of information that will help potential buyers learn about the history of such a car. Thus, updates done into the booklet associated to the car by previous owners will be transferred to the last buying party.

In the same way, the booklet related to the employer can comprise feedback about the employer, a rating of the employer by the user, and so on.

An application illustrating the utility of generating a booklet for the employer could be for automatically generating a rating of the employer using the information stored in the booklet. If a plurality of booklets associated with different users relate to the same employer, a rating of the employer based on the information provided by these various users through their corresponding booklets could be generated.

The booklets are generated according to booklet generating criteria that can dynamically be defined by the user using the user interface 56. The booklets can also be generated automatically using predefined booklet generating criteria stored in an accessible database. The process of generating the booklets could be triggered by the user through a user request comprising the booklet generating criteria.

The booklet generating criteria can consist of an identification of at least one social object among the social objects related to the user. In this case, the digital booklets are generated based on the at least one social object identified by said user, in such a way that every booklet related to a given social object contains all the information provided by the user in relation with the given social object.

The third step consists of updating the booklets over time 14. Since each booklet is independent from the others in term of data continence and data access, an accurate identification of the booklet to update is required. In the same optic, a cotenant update of a given booklet does not affect a cotenant of other booklets associated with the same user.

This process of updating the booklets can be carried out by the user or another authorized person.

The fourth step consists of tracking and cataloguing the booklets over time 16. The process of tracking and cataloguing the booklets over time can consist of tracking and cataloguing user's real life experience with the various social objects related to the generated booklets over time.

Generally, this step is automated and is triggered when the booklet is generated and each time the booklet is updated. The tracking and cataloguing process is carried out according to predefined tracking and cataloguing criteria. This criterion could be defined by the user or by the system administrator.

Data records associated with the tracking and cataloguing process are generated and are stored in a third database 54.

In a preferred embodiment, this method is computer-implemented and the steps 12, 16 and 18 are automated.

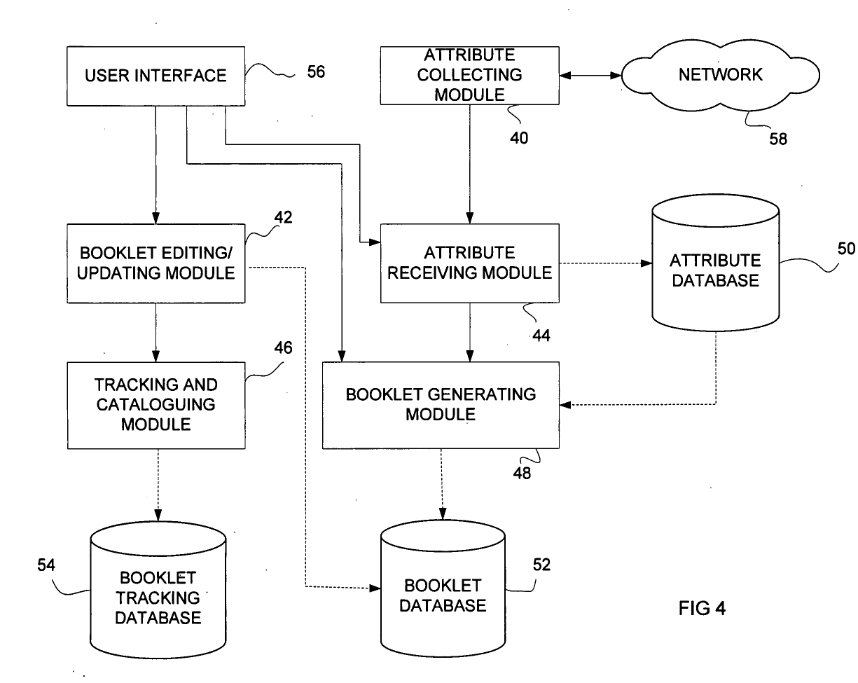

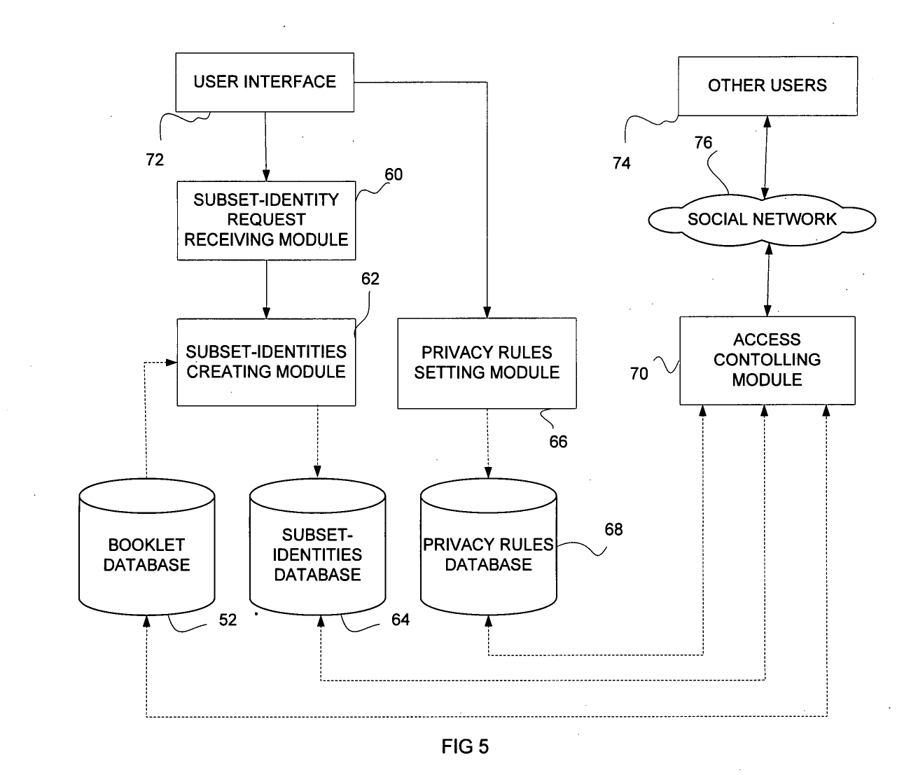

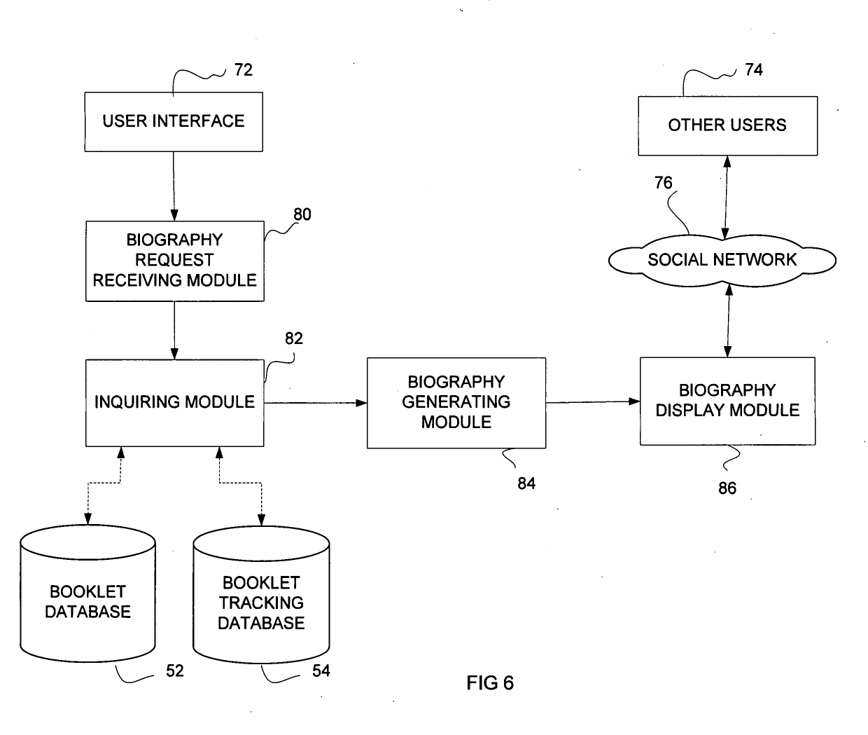

From a system perspective, referring to FIG. 4, there is provided a system for building a digital identity of a user. The system comprises a user interface 56, an attribute collecting module 40, an attribute receiving module 44, a booklet editing/updating module 42, a booklet generating module 48, a tracking and cataloguing module 46, an attribute database 50, a booklet database 52 and a booklet tracking database 54.

The attribute receiving module 44 is adapted for receiving profile attributes associated with the user. As mentioned hereinabove, the profile attributes comprise intrinsic attributes that inherently define the user and extrinsic attributes that comprise information about social objects and about relations therewith.

The attribute receiving module 44 is adapted to be connected to user interface 56 for enabling the user to manually upload the profile attributes. The attribute receiving module 44 is also adapted to be connected to an attribute collecting module 40 that is adapted to be connected to a data network 58 for automatically collecting the profile attributes from a local or remote database, device or interface connected to the data network 58.

The attribute receiving module 44 is further connected to an attribute database 50 for storing the received attributes.

The booklet generating module 48 is connected to the user interface 56 for receiving booklet generating criteria and to the attribute receiving module 44 for receiving a set of attributes, where the booklet generating module 48 is programmed for generating a plurality of digital booklets comprising digital information associated with the received attributes as a function of the booklet generating criteria.

The booklet generating module 48 converts the received attributes in a convenient digital format to be integrated into the booklets. The generated booklets are then stored in a booklet database 52.

It should be evident for a person skilled in the art that the process of receiving attributes by the attribute receiving module 44 and the process of generating booklets can be carried out separately in term of time frame. In this case, the attributes are already stored in the attribute database 50 when the booklet generating module 48 receives a request for generating booklets accompanied by the booklet generating criteria. The booklet generating module 48 retrieves appropriate attributes from the attribute database 50 based on the booklet generating criteria and then generates the digital booklets.

As mentioned, the booklet generating criteria can be defined by the user via the user interface 56 for example, or predefined and stored in storage means connected to the booklet generating module 48.

The social reality of a person is reflected by the intrinsic attributes of the person as well as by his interactions with the elements of his environment (social objects). Generally, each booklet reflects a distinct aspect of the user via his social objects that is represented by a booklet.

II—Sharing a Digital Identity

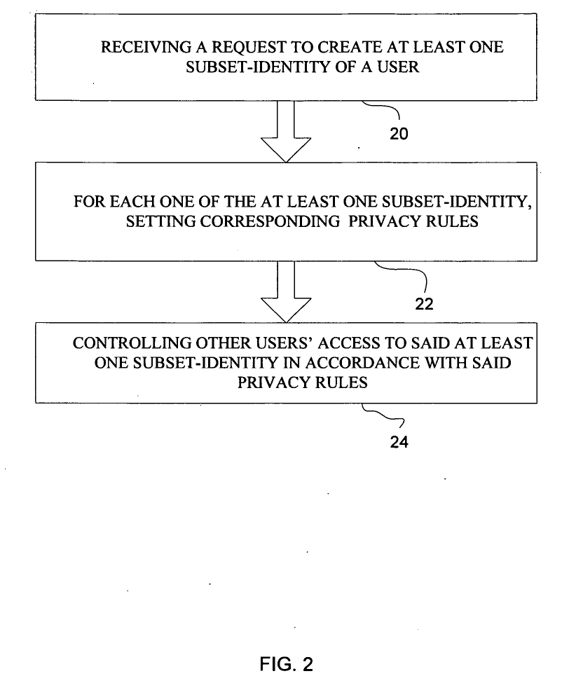

Referring to FIG. 2, there is provided a method for sharing a digital identity associated with a user. The first step of the method consists of receiving a request to create at least one subset-identity (also called facet) of the user, where each one of the at least one subset-identity is associated with at least one digital booklet containing digital information associated with attributes of the user 20.

According to a preferred embodiment, the method is computer-implemented over a social network.

The subset-identities (facets) can be organized according to various logical graphs. The facets can be logically organised in an isolated manner or in a hierarchical manner where each hierarchical facet is associated with a degree of intimacy, with the most personal profile on the top of the pile (highest degree of intimacy) and the less personal at the bottom (lower degree of intimacy).

A hierarchical organization of facets enables for carrying out interesting methods of managing the facets and securing intimacy violation by other users over social networks. For example, in a hierarchy organized facets, it can be defined that peers in an upper profile can have knowledge of the reality represented in the lower facet, but not the opposite.

In other terms, facets may be managed and connected with one another by a user to expose different identity to others. A user can create 2 types of facets structures: hierarchical facets and non-hierarchical facets that are also known as isolated facets.

The hierarchical facets are ordered by intimacy, with your most personal facet on the top and the less important at the bottom of the pile. You can promote or demote peers between such hierarchical facets depending on the intimacy and/or context of your relationship with them.

In hierarchy-based facets, peers in an upper facet have knowledge of your reality presented in the lower facet. Peers in any of your defined-profiles can see same-profile-mates, while peers in lower profiles won't have knowledge of friends in an upper facet.

Conversely to hierarchical facets, with non-hierarchical (or isolated) facets, you can create part of your reality that is only known by selected peers which are only part of each of these facets.

Thus, the isolated facets behave quiet differently from hierarchical facets where peers on a top-facet are aware of your reality represented in a profile facet at the bottom of the hierarchy.

As a method of implementation, users may also use a table containing his assets as rows and his facets as columns. Here, assets may include photos, videos, booklets, contacts, and collections of these elements. From this tableau the user may them check or uncheck the appropriate to associate or dissociate a given asset with a given facet. For example, Bob may associate Alicia to facet A and facet B by checking position P1 and P2. Bob can also associate Mat to facet B and facet C by checking position P6 and P9. Finally, Bob may also associate his booklet 1 about his boat with Facet B, and his booklet 2 about his son with facet C by checking positions P3 and P5. With this configuration Mat's view of Bob's profile will be different to Alicia's view of Bob's profile. Indeed, when visiting Bob's profile, Alicia will never find out that Bob has Mat as a friend, and Alicia will never find out that Bob's maintain a booklet about his Porsche.

According to this embodiment of the invention, by using the member interface 20, the member can associate with each one of the facets a correspondent degree of intimacy.

The subset-identities (facets) creating module 62 is adapted to be connected to a subset-identities database for storing therein data records associated with the plurality of subset-identities (facets) and with the correspondent associated degrees of intimacy if it is the case.

The second step consists of setting corresponding privacy rules for each one of the at lest one subset-identity 22. The privacy rules are set by the user using the user interface 72.

The third step consists of controlling other users' access to the at least one subset-identity in accordance with the privacy rules set by the user 24.

The privacy rules generally comprise access privileges, interaction privileges and administration privileges.

The access privileges comprise information allowing for identifying users eligible for visualizing the digital information contained in the at least one digital booklet.

For example, an owner of a booklet may grant access to all or part of his booklet to others depending on the intimacy of the relationships with them. Thus, the owner of the booklet will only maintain one digital symbol while projecting different perceptions of its image through such an object. For example, let assume that Bob has a boat, and during one summer, he throw a party on his boat with old time friends that, Brenda, his girlfriend doesn't like. Bob can decide not to grant Brenda access to facts related to the party on his booklet associated to boat. Thus, the perception of the boat (which is part of Bob's reality) will be different for Bob's friends and Brenda, Bob's girlfriend. This is perception management (or is it lies?). Whatever it is call, this is a real life behavior and this embodiment of the invention shows how such an experience can be mimicked in the digital realm.

In this case, the access control process to the at least one subset-identity consists of, as a first step, determining users eligible to visualize information contained in the at least one digital booklet and, as a second step, of granting the eligible users access to visualize the at least one digital identity in accordance with the access privileges.

The method can comprise a supplementary step of setting hierarchical access rules between the at least two subset-identities for enabling eligible users granted access to a subset-identity of an upper level to be automatically granted access to one or more subset-identities of a lower level, and, if required, automatically granting the eligible users access to two or more subset-identities among the at least two-subset identities in accordance with the hierarchical access rules.

The interaction privileges comprise information allowing for identifying users eligible to interact with at least one other eligible user through the at least one digital booklet.

In this case, the access control process to the at least one subset-identity consists of, as a first step, determining users eligible to interact with at least one other eligible user through the at least one digital booklet and, as a second step, enabling the eligible users to interact with at least one other eligible user through the at least one digital booklet in accordance with the interaction privileges. The at least one digital booklet can be used as a mean of interaction or a subject of discussion.

In another scenario of social interaction, a user may be associated with a preferred facet, while being granted access to other facets within one's account. For example, Bob may choose to define a preferred context based on the level of intimacy of his relationship with others. In this case, Bob has set Facet A as the preferred context of interaction with Alicia. Thus, when visiting Bob's profile, Alicia will preferably see Bob's intrinsic attributes within the facet B, even thus Bob may have different intrinsic attributes within Facet B and Facet C. Additionally, Alicia may also have privileges inherited from facet A when interacting within Facet B and C. For example, Alicia may inherited editing rights from facet A even thus such right may not have been granted explicitly granted by Bob with Facet B and C.

The administration privileges comprise information allowing for identifying users eligible to carry out administration actions in connection with the at least one digital booklet.

In this case, the access control process to the at least one subset-identity consists of, as a first step, determining users eligible to carry out administration actions in connection with the at least one digital booklet and, as a second step, enabling the eligible users to carry out administration actions in accordance with the defined administration privileges.

The administration actions can consist of updating content of the at least one booklet, editing content of the at least one booklet, setting rules for receiving feeds through the at least one booklet and setting privileges to other users in connection with the at least one booklet.

As another scenario of social interaction, Alicia may want to include a special friend, Max, into given facets with her other friends. However, she might want to restrict some of her intrinsic attributes to Max. For example, Alicia may want to hide her birth date to Max to keep her age private. She may also want to hide or display another matrimonial status (Single, Divorced, etc.). With this invention, Alicia may choose to edit Max's access to her attributes, either from her list of contacts or from Max's profile page. This way, Max will only see limited or different intrinsic attributes of Alicia, conversely to her others friends.

The information allowing for identifying eligible users can be defined as a type or a group of eligible users or by identifiers allowing for uniquely identifying the eligible users (email address, name, phone, etc.).

In one embodiment, the method is implemented on a computer server connected to a social network, and the other users consist of users pre-registered on a database connected to the computer server or on another platform independent of the computer server.

From a system perspective, referring to FIG. 5, there is provided a system for sharing a digital identity of a user. The system comprises: a user interface 72, a subset-identity request receiving module 60, a subset-identities creating module 62, a privacy rules setting module 66, an access controlling module 70, a booklet database 52, a subset-identities database 64 and a privacy rules database 68.

The subset-identity request receiving module 60 is adapted to be connected to the user interface 72 for receiving from a user a request to create at least one digital subset-identity. The request comprises information allowing for identifying at least one booklet to be associated with each one of the at least one subset-identity (facet) to create.

The subset-identities creating module 62 is connected to the subset-identity request receiving module 60, to a booklet database 52 and to a subset-identities (facets) database 64 for receiving the request, inquiring the booklet database as a function of the request, and for associating each one of the at least one subset-identity with at least one digital booklet stored in the first database 6. As mentioned hereinabove, the digital booklets contain digital information associated with attributes of the user. The subset-identities creating module 62 stores data records associated with the created subset-identities in the subset-identities database 64.

The privacy rules setting module 66 is connected to the user interface 72 for setting, for each one of said at least one subset-identity, corresponding privacy rules. As mentioned hereinabove, the privacy rules generally comprise access privileges, interaction privileges and administration privileges. The privacy rules setting module 66 is connected to the privacy rules database 68 for storing data records about the privacy rules.

The access controlling module 70 is connected to the booklet database 52, to the subset-identities database 64 and to the privacy rules database 68 and to a social network 76 for controlling other users' access to the at least one subset-identity in accordance with the privacy rules.

In one embodiment of the present invention, the access controlling module 70 receives a request from a given user 74 of the social network 76 to access, to administrate or to interact with at least one other eligible user via a given subset-identity (facet) of the first user. The access controlling module 70 inquires the privacy rules database 68 for determining if the given user is an eligible user as a function of the type of action required thereby. If the given user is eligible, the access controlling module 70 inquires the subset-identities database 64 to determine an identity of the at least one booklet associated with the given subset-identity, and enables the given user, as a function of the corresponding privacy rules, to access, administrate or interact with at least one other eligible user via the at least one booklet stored in the booklet database 52.

III—Generating a Biography

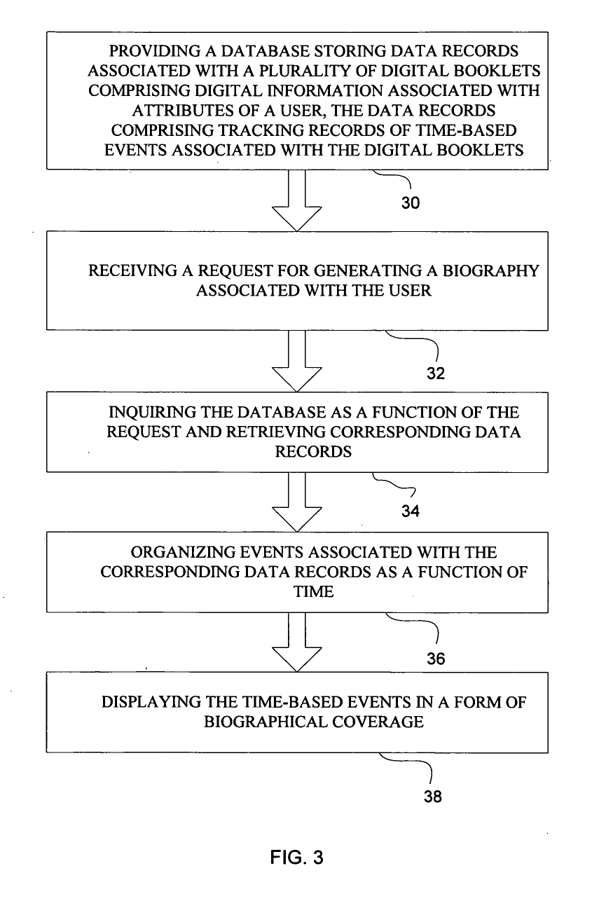

Referring to FIG. 3, there is provided a method of generating a biography associated with a user. The first step of the method consists of providing a booklet database 52 storing data records associated with a plurality of digital booklets comprising digital information associated with attributes of the user, where the data records comprise tracking records of time-based events associated with the digital booklets 30. The booklet database 52 and the booklet tracking database 54 are generally built according to the method of building a digital identity of a user described hereinabove. As mentioned hereinabove, the attributes comprise intrinsic attributes that inherently define the user and extrinsic attributes that comprise information about social objects and about relations of the user with social objects.

The second step consists of receiving at a computing device connected to the booklet database 52 a request for generating a biography associated with the user 32. The request should comprise information allowing for determining at least one booklet associated with the request and a time frame to be covered by the biography. This information could be an identification of a given social object belonging to the extrinsic attributes of the user.

The third step consists of inquiring the booklet database 52 as a function of the information embedded in the received request, and retrieving corresponding data records thereof 34. The corresponding data records are associated with at least one digital booklet determined in accordance with the information embedded in the request. If the request is related to given social object, the corresponding data records are then related to the given social object.

The fourth step consists of organizing events associated with the corresponding data records as a function of time 36.

The fifth step consists of displaying the time-based events in a form of biographical coverage 38.

In a preferred embodiment, the method is computer-implemented over a social network, and the steps 34, 36 and 38 are automated.

From a system perspective, there is provided a system for generating a biography associated with the user. The system comprises a user interface 72, a biography request receiving module 80, an inquiring module 82, a biography generating module 84, a biography display module 86, a booklet database 52 and a booklet tracking database 54.

As described hereinabove, the booklet database 52 stores data records associated with a plurality of digital booklets comprising digital information associated with attributes of a user. The booklet tracking database 54 stores tracking records of time-based events associated with the digital booklets.

The biography request receiving module 80 is connected to the user interface 72 for receiving a request for generating a biography associated with a user. The request comprises information allowing for determining at least one booklet associated with the request and a time frame to be covered by the biography. The user interface 72 allows users of the social network to manually define the request.

The inquiring module 82 is connected to the biography request receiving module 80, to the booklet database 52 and to the booklet tracking database for inquiring these databases as a function of the information embedded in the request and for retrieving corresponding data records thereof.

The inquiring module 82 is further connected to the biography generating module 84 for transmitting thereto the corresponding data records retrieved from the databases 52 and 54. The biography generating module 84 receives the corresponding data records, organizes events associated with the corresponding data records as a function of time and generates the biography.

The biography display module 86 is connected to the biography generating module 86 and to the social network 76 for displaying the time-based events in a form of biographical coverage.

As an example, friends and family members can maintain booklets about peers. Then, when comes a special event like birthday, marriage or any other celebration of a member, his friends can offer their digital booklet as a gift. Such offers will not only help the member leaning what other thing about him but also help him make adjustment to maintain his relationship with others. This can also be done to generate one's biography or perception according to others, or stories relative to objects in one's environment.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

The embodiment(s) of the invention described above is(are) intended to be exemplary only. The scope of the invention is therefore intended to be limited solely by the scope of the appended claims.

1. A method of building a digital identity, the method comprising:
receiving profile attributes associated with a user;
generating a plurality of digital booklets comprising digital information associated with said attributes;
updating said booklets over time; and
tracking and cataloguing said booklets over time.

2. The method as claimed in claim 1, wherein said method is computer-implemented.

3. The method as claimed in claim 2, wherein said attributes comprise intrinsic attributes that inherently define said user and extrinsic attributes that comprise information about social objects and about relations of said user with said social objects.

4. The method as claimed in claim in 3, wherein said tracking and cataloguing said booklets over time comprises tracking and cataloguing user's real life experience with said social objects over time through said booklets.

5. The method as claimed in claim 3, wherein said attributes are stored into a first database and said generated digital booklets are stored into a second database.

6. The method as claimed in claim 5, further comprising generating data records associated with said tracking and cataloguing said booklets over time, and storing said data records into a third database.

7. The method as claimed in claim 3, wherein said social objects are related to at least one category of products, animals, things, people, places and interests.

8. The method as claimed in claim 7, wherein said received attributes are in a textual or a multimedia format.

9. The method as claimed in claim 3, wherein said method is implemented on a computer server connected to a social network, said profile attributes are automatically collected from one or more databases independent from said computer server.

10. The method as claimed in claim 9, wherein said generating digital booklets is carried out automatically using predefined booklet generating criteria.

11. The method as claimed in claim 10, wherein said profile attributes comprising intrinsic and extrinsic attributes are stored into a first database, and said digital booklets are generated based on at least one social object among said social objects by extracting information related thereto from said first database.

12. The method as claimed in claim 11, wherein said tracking and cataloguing said booklets over time is carried out automatically using predefined tracking and cataloguing criteria.

13. The method as claimed in claim 12, wherein said tracking and cataloguing criteria is predefined by said user.

14. The method as claimed in claim 3, wherein said method is implemented on a computer server connected to a social network, said profile attributes are transmitted by said user using at least one of a user interface connected to said computer server and a device operating independently of the computer server.

15. The method as claimed in claim 14, further comprising receiving a request from said user for generating said digital booklets, where said request comprises said booklet generating criteria.

16. The method as claimed in claim 15, wherein said booklet generating criteria comprises an identification of at least one social object among said social objects, and said digital booklets are generated based on said at least one social object identified by said user.

17. The method as claimed in claim 16, wherein said updating said booklets over time is carried out by said user.

18. A method of sharing a digital identity the method comprising:
receiving from a first user a request to create at least one digital subset-identity, where each one of said at least one subset-identity is associated with at least one digital booklet containing digital information associated with attributes of said user;
for each one of said at least one subset-identity, setting corresponding privacy rules; and
controlling other users' access to said at least one subset-identity in accordance with said privacy rules.

19. The method as claimed in claim 18, wherein said method is computer-implemented.

20. The method as claimed in claim 19, wherein said method is implemented over a social network.

21. The method as claimed in claim 20, wherein said corresponding privacy rules comprise access privileges comprising information allowing for identifying users eligible for visualizing said digital information contained in said at least one digital booklet, and said controlling other users' access to said at least one subset-identity comprises determining users eligible to visualize information contained in said at least one digital booklet and granting said eligible users said access to visualize in accordance with said access privileges.

22. The method as claimed in claim 21, wherein said at least one subset-identity consist of at least two subset-identities, said method further comprising setting hierarchical access rules between said at least two subset-identities for enabling eligible users granted access to a subset-identity of an upper level to be automatically granted access to one or more subset-identities of a lower level, and, if required, automatically granting said eligible users access to said at least two-subset identities in accordance with said hierarchical access rules.

23. The method as claimed in claim 20, wherein said corresponding privacy rules comprise interaction privileges comprising information allowing for identifying users eligible to interact with at least one other eligible user through said at least one digital booklet, and said controlling other users' access to said at least one subset-identity comprises determining users eligible to interact with at least one other eligible user through said at least one digital booklet and enabling said eligible users to interact with said first user through said at least one digital booklet in accordance with said interaction privileges.

24. The method as claimed in claim 23, wherein said enabling said other users to interact with at least one other eligible user through said at least one digital booklet comprises enabling said other users to use said at least one digital booklet as at least one of a mean of interaction and a subject of discussion.

25. The method as claimed in claim 20, wherein said corresponding privacy rules comprise administration privileges comprising information allowing for identifying users eligible to carry out administration actions in connection with said at least one digital booklet, and said controlling other users' access to said at least one subset-identity comprises determining users eligible to carry out administration actions in connection with said at least one digital booklet and enabling said eligible users to carry out said administration actions in accordance with said defined administration privileges.

26. The method as claimed in claim 25, wherein said administration actions comprise at least one of updating content of said at least one booklet, editing content of said at least one booklet, setting rules for receiving feeds through said at least one booklet and setting privileges to other users in connection with said at least one booklet.

27. The method as claimed in claim 25, wherein said information allowing for identifying eligible users consist of user selection criteria comprising at least one of a type and a group of eligible users.

28. The method as The method as claimed in claim 25, wherein said information allowing for identifying eligible users consist of predefined identifiers allowing for uniquely identifying said users.

29. The method as claimed in claim 28, wherein said method is implemented on a computer server connected to said social network, and said other users consist of users pre-registered on a database connected to said computer server or on another platform independent of said computer server.

30. The method as claimed in claim 29, wherein said attributes comprise intrinsic attributes that inherently define said user and extrinsic attributes that comprise information about social objects about relations of said user with said social objects.

31. The method as claimed in claim 30, wherein said request is transmitted by said user using at least one of a user interface connected to said computer server and a device operating independently of the computer server.

32. A method of generating a biography, the method comprising:
providing a first database storing data records associated with a plurality of digital booklets comprising digital information associated with attributes of a user, where said data records comprise tracking records of time-based events associated with said digital booklets;
receiving at a computing device connected to said first database a request for generating a biography associated with said user, the request comprising information allowing for determining at least one booklet associated with the request and a time frame to be covered by said biography;
inquiring said first database as a function of said information and retrieving corresponding data records thereof;
organizing events associated with said corresponding data records as a function of time; and
displaying said time-based events in a form of biographical coverage.

33. The method as claimed in claim 32, wherein said method is computer-implemented.

34. The method as claimed in claim 33, wherein said attributes comprise intrinsic attributes that inherently define said user and extrinsic attributes that comprise information about social objects and about relations of said user with said social objects.

35. The method as claimed in claim 34, wherein said biography associated with a user consist of a biography associated with a social object among said social objects of said user.

36. A system for building a digital identity of a user, the system comprising:
a first module for receiving profile attributes associated with said user;
a first database for storing said attributes;
a second module for generating a plurality of digital booklets comprising digital information associated with said attributes;
a second database for storing said generated booklets;
a third module for updating said booklets over time;
a fourth module for tracking and cataloguing said booklets over time and for generating data records associated therewith; and
a third database for storing said generated data records.

37. The system as claimed in claim 35, further comprising a user interface adapted to be connected to said first module for enabling said user to manually upload said profile attributes.

38. The system as claimed in claim 36, wherein said user interface comprises features for enabling said user to define booklet generating criteria, wherein said generating a plurality of digital booklets is carried out as a function of said defined booklet generating criteria.

39. The system as claimed in claim 35, further comprising a fifth module adapted to be connected to said first module for automatically collecting said profile attributes from a remote device through a data network.

40. A system for sharing a digital identity, the system comprising:
a first module for receiving from a user a request to create at least one digital subset-identity;
a second module for associating each one of said at least one subset-identity with at least one digital booklet stored in a first database, said at least one digital booklet containing digital information associated with attributes of said user;
a second database for storing data records about said at least one subset-identity;
a third module for setting, for each one of said at least one subset-identity, corresponding privacy rules;
a third database for storing data records about said privacy rules;
a fourth module adapted to be connected to a social network and to said first, second and third databases for controlling other users' access to said at least one subset-identity in accordance with said privacy rules.

41. The system as claimed in claim 40, further comprising a user interface adapted to be connected to said first module for enabling said user to define manually said request.

42. The system as claimed in claim 41, wherein said user interface is further connected to said third module for enabling said user to set manually said privacy rules.

43. A system for generating a biography associated with a user, the system comprising:
a database storing data records associated with a plurality of digital booklets comprising digital information associated with attributes of a user, where said data records comprise tracking records of time-based events associated with said digital booklets;
a first module for receiving a request for generating a biography associated with a user, the request comprising information allowing for determining at least one booklet associated with the request and a time frame to be covered by said biography;
a second module for inquiring said first database as a function of said information and retrieving corresponding data records thereof;
a third module for generating said biography, where said generating comprises organizing events associated with said corresponding data records as a function of time; and
a fourth module for displaying said time-based events in a form of biographical coverage.

44. The system as claimed in claim 43, further comprising a user interface for enabling users to define said request for generating a biography.
